(19) United States
(12) Patent Application Publication
(10) Pub. No.: US 2011/0073192 A1
(43) Pub. Date: Mar. 31, 2011

(54) SYSTEM AND METHOD FOR MANAGING LOAD FLOW REQUIREMENTS FOR A TRACTOR SINGLE PUMP HYDRAULIC SYSTEM

(76) Inventor: David V. Hart, Vancouver (CA)

(21) Appl. No.: 12/843,835

(22) Filed: Jul. 26, 2010

Related U.S. Application Data
(60) Provisional application No. 61/228,498, filed on Jul. 24, 2009.

(51) Int. Cl. F15D 1/00

(52) U.S. Cl. 137/14

(57) ABSTRACT

A system and method for managing hydraulic fluid load flow requirements for a tractor having a single pump hydraulic system. The system connects a hydraulic implement in parallel and gives precedence to the tractor's essential operations, such as a hydraulic steering system, to be controlled independently of the hydraulic pressure requirements of the implement system. The method includes determining the essential operation fluid pressure requirement; determining the implement fluid pressure requirement; and maintaining the essential operation fluid pressure requirement by providing hydraulic fluid flow to the essential operation regardless of the implement fluid pressure requirement.

### CROSS REFERENCE TO RELATED APPLICATION

This application claims the priority of U.S. Provisional Patent Application No. 61/228,498 entitled “SYSTEM AND METHOD FOR MANAGING LOAD FLOW REQUIREMENTS FOR A TRACTOR SINGLE PUMP HYDRAULIC SYSTEM,” filed Jul. 24, 2009, the contents of which are hereby incorporated by reference.

### FIELD OF THE INVENTION

The present invention relates to land vehicle hydraulic systems generally and more specifically to pipelayer hydraulic assemblies mounted to track-type tractors.

### BACKGROUND OF THE INVENTION

Hydraulic track-type pipelayers consist of a track-type crawler tractor with a pipelayer structure mounted to it, along with the associated hydraulic hook and boom winches, the winch hydraulic-controls, and all the necessary rigging. The track-type crawler tractor provides the power to drive the hydraulic winches, and any other hydraulic system fitted or used to control the crawler tractor.

The pipelayer hydraulic system can be driven either directly with a dedicated implement pump supplying only the pipelayer system, or connected in parallel with the tractor hydraulic implement system. The tractor implement system is also arranged in parallel. A parallel system means that when hydraulic functions are actuated simultaneously, hydraulic fluid flow is divided to each function. It is known however, that there will be a greater flow to the path with the least resistance. Due to this fact, the pipelayer is connected to the tractor implement system in parallel, either the tractor implement system or the pipelayer system could be impaired when used simultaneously. This is because the fluid directed to the path of least resistance could leave the other system with insufficient hydraulic pressure to adequately operate that system. This is typically not an issue with the pipelayer system, since all other existing implements—bulldozer cylinders, rippers, tow winches, etc.—are typically either removed or disconnected, or are not used during critical pipelaying operations. The same is not true, however, for essential hydraulic operations such as the tractor steering system.

Crawler tractors have two methods for steering control: mechanical steering clutches, or hydraulic differential steering. Mechanical steering clutches are completely separate from the hydraulic implement system, and are unaffected by it. Hydraulic differential steering systems use a hydraulic steering motor to facilitate a change of direction. The hydraulic steering motor can be powered either by its own dedicated pump, separate from the implement system (a two-pump system), or by the tractor implement pump (a single-pump system).

In a single pump system, the steering function could be severely compromised unless it is given precedence over the other tractor implement functions. With a pipelayer connected directly to a single-pump system which also services the steering function, the steering of the tractor could be drastically impaired if a load placed by the pipelayer implement consumes hydraulic flow, leaving insufficient flow for the steering function. For example, if the tractor was making a turn while quickly raising an empty hook, the hook winch would have a very low pressure requirement (least resistance) while having a high flow requirement. In this example, the majority of hydraulic fluid would flow through the pipelayer's hook circuit, leaving significantly less, and potentially insufficient, flow for the steering function. This is an extremely undesirable situation. For this type of reason, single pump differential steering systems have not been successfully implemented on tractors including implements such as pipelayers, and therefore pipelayers have been primarily used on crawler tractors with mechanical steering clutches. A need, therefore, exists for a single pump differential steering system and method for a tractor including hydraulic implement, such as a pipelayer connected in parallel thereto, wherein the tractor steering system, or any other essential hydraulic system, is not affected by the hydraulic flow requirements of the implement (pipelayer).

### SUMMARY OF THE INVENTION

The system of the present disclosure connects an implement hydraulic system to a single-pump, differential steer, crawler tractor's implement valve in parallel. The present load-flow system and process gives precedence to the tractor's essential operation which is in hydraulic fluid communication with an implement system (such as a pipelayer), by allowing the hydraulic power (pressure and flow) to be controlled in the essential operation independently of the hydraulic pressure requirements of the implement system. As a result, full control of the essential hydraulic operation is maintained regardless of the implement system demands. A secondary function and sub-process also allow either the tractor's essential operation, or the implement system, to dictate the implement pump's supply-pressure output. As used herein, the term essential operation shall include any system of the tractor which relates to its essential operation and function, such as, but not limited to, the steering system.

In its general form, the present disclosure includes a process for managing fluid flow for an essential operation and an implement connected in parallel to a single hydraulic pump. The process includes the steps of determining the essential operation fluid pressure requirement; determining the implement fluid pressure requirement; and maintaining said essential operation fluid pressure requirement by providing fluid flow to the essential operation regardless of the implement fluid pressure requirement.

In a preferred embodiment, the present disclosure includes a process for managing fluid flow requirements for a steering system and a pipelayer system connection in parallel to a single pump hydraulic system. The process includes the steps of:
(1) obtaining a steering system fluid pressure requirement from the essential operation system;
(2) obtaining a pipelayer fluid pressure requirement from the pipelayer system;
(3) determining a greatest system pressure requirement;
(4) transmitting the greatest system pressure requirement signal to the single pump hydraulic system;

(5) obtaining fluid flow from the single pump hydraulic system to maintain the greatest system pressure requirement; and
(6) maintaining fluid flow to satisfy the steering system fluid pressure requirement independent of the pipelayer system fluid pressure requirement.

Further aspects, features, and advantages of the present invention will be apparent to those of ordinary skill in the art upon examining the accompanying drawings and upon reading the following detailed description of the preferred embodiments.

### BRIEF DESCRIPTION OF THE DRAWINGS

FIG. 1 depicts a schematic diagram of a single pump parallel hydraulic system including the apparatus and process of the present disclosure.

### DETAILED DESCRIPTION OF THE PREFERRED EMBODIMENTS

The system of the present disclosure in a preferred embodiment connects a pipelayer hydraulic system to a single-pump, differential steer, crawler tractor's implement valve in parallel. It gives precedence to the tractor's steering and implement system by allowing the hydraulic power (pressure and flow) to be controlled in the steering system independently of the hydraulic pressure requirements of the pipelayer system. In this way, full steering control is maintained regardless of the pipelayer system demands. A secondary function also allows either the tractor steering and implement system or the pipelayer system to dictate the implement pump's supply-pressure output. Without the system of the present disclosure installed, steering control of single-pump, differential steer, crawler tractors would be unreliable with a hydraulic pipelayer system installed.

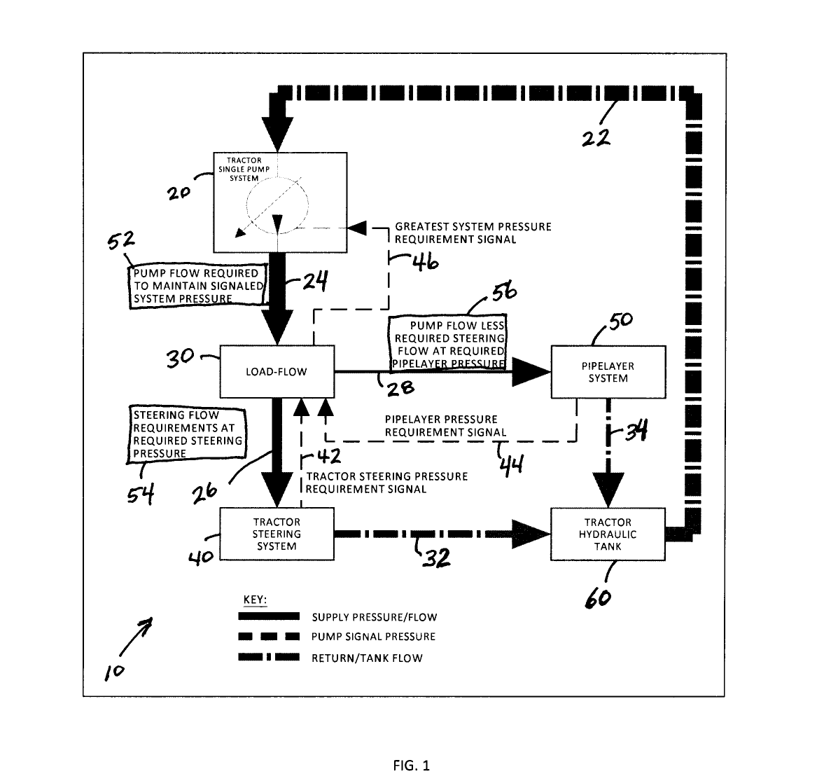

With reference to FIG. 1, a tractor hydraulic steering system connected to a pipelayer hydraulic system in parallel 10 is disclosed. System 10 includes a tractor single-pump system 20, the load flow hydraulic fluid flow apparatus of the present disclosure 30, tractor steering system 40, pipelayer system 50, and tractor hydraulic tank 60. In system 10, load-flow apparatus 30 and pipelayer system 50 are preferably connected to the implement valve of a crawler tractor in parallel such that the tractor single pump 20 is in fluid communication with load-flow 30, which is, in turn, in fluid communication with both the tractor steering system 40 and pipelayer system 50. Tractor single pump 20, tractor steering system 40, and pipelayer system 50 are in fluid communication with tractor hydraulic tank 60.

Hydraulic fluid is pumped by tractor single pump 20 from hydraulic tank 60, shown by flow diagram 22. Hydraulic fluid is pumped by the tractor single pump 20 into load flow apparatus 30, as shown at 24. Load flow apparatus 30 obtains the fluid flow pressure requirements of the tractor steering system and provides hydraulic fluid flow to steering to tractor steering system 40, as shown at 26. Load flow apparatus 30 also obtains the fluid flow pressure requirements of pipelayer system 50 and provides fluid flow to pipelayer system 50 at 28. Load flow apparatus 30 satisfies the fluid flow pressure requirements of tractor steering system 40 regardless and independent of the fluid flow pressure demands of pipelayer system 50. Fluid is returned by tractor steering system 40 to hydraulic tank 60, as shown at 32. Fluid is returned by pipelayer system 50 to hydraulic tank 60, as shown at 34.

In operation, tractor steering system 40 provides a signal 42 to load flow apparatus 30 regarding the fluid flow pressure required for proper tractor steering system function. Pipelayer system 50 provides a signal 44 to load flow apparatus 30 regarding the fluid pressure requirement necessary for operation of the pipelayer system. From tractor steering pressure requirement signal 42 and pipelayer pressure requirement signal 44, load flow apparatus 30 determines the greatest system pressure requirement necessary for the proper function of tractor steering system 40 and/or pipelayer system 50. This is done by comparing the tractor steering system pressure requirement signal 42 with pipelayer pressure requirement signal 44. Load flow apparatus 30 provides a signal 46 to tractor single pump 20 regarding this greatest system pressure requirement 46. Load flow apparatus 30 may include a microprocessor for receiving signals 42 and 44 and for determining the greatest system pressure requirement, the microprocessor may also include as an output for providing the greatest system pressure requirement signal 46 to single pump system 20.

In response to the greatest system pressure requirement signal 46, the tractor single pump system 20 provides the fluid flow required to maintain the signaled greatest system pressure at 52. Load flow apparatus 30 receives the flow required to maintain the greatest signal system pressure 52 from tractor pump system 20. Load flow apparatus 30 distributes the fluid flow required by tractor steering system 40 at the required pressure 54. Load flow apparatus 30 also provides fluid flow to pipelayer system 50. The fluid flow to pipelayer system 50 from load flow apparatus 30 is the pump flow required to maintain the greatest system signaled pressure 52 less the fluid flow requirements at the required steering pressure 54 required by steering system 40. In this way, load flow apparatus 30 maintains at all times the required fluid flow to tractor steering system 40 at the required steering fluid pressure, regardless and independent of the pipelayer system 50. In the event that the pipelayer system pressure requirement (per signal 44) of pipelayer system 50 is less than the tractor steering system requirement (per signal 42) of tractor steering system 40, load flow apparatus 30 will provide the necessary fluid flow to tractor steering system 40 required to maintain the tractor steering pressure requirement without a pressure drop due to fluid flow taking the path of least resistance caused by the lower pressure request of pipelayer system 50.

Load flow apparatus 30 may also provide the necessary fluid flow to maintain the required system pressure in either tractor steering system 40 or pipelayer system 50, depending on which produces the greatest system pressure requirement, which then becomes the greatest system pressure requirement signal 46. In this way, either the tractor steering system 40 or the pipelayer system 50 may dictate the pump flow 52 required to maintain the greatest system pressure (per signal 46).

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A process for managing fluid flow requirements for a tractor steering system and a pipelayer system connected in parallel to a single pump hydraulic system, comprising:
determining the tractor steering system fluid pressure requirement;
obtaining fluid flow from the single pump hydraulic system;
providing fluid flow to satisfy the tractor steering system fluid pressure requirement; and
providing fluid flow to the pipelayer system independent of the fluid flow provided to satisfy the tractor steering system fluid pressure requirement.

2. The process of claim 1 further including determining the pipelayer system fluid pressure requirement.

3. The process of claim 2 wherein fluid flow is provided to the pipelayer system necessary to satisfy the pipelayer system fluid pressure requirement.

4. The process of claim 2 further including comparing the tractor steering system fluid pressure requirement and the pipelayer system fluid pressure requirement to determine a greatest system fluid pressure requirement.

5. The process of claim 4 including obtaining fluid flow from the single pump hydraulic system to satisfy the greatest system fluid pressure requirement.

6. A process for managing fluid flow for an essential operation and an implement connected in parallel to a single hydraulic pump, comprising:
determining the essential operation fluid pressure requirement;
determining the implement fluid pressure requirement; and
maintaining said essential operation fluid pressure requirement by providing fluid flow to the essential operation regardless of the implement fluid pressure requirement.

7. The process of claim 6 wherein fluid flow is provided to the implement necessary to satisfy the implement fluid pressure requirement.

8. The process of claim 6 further including comparing the essential operation fluid pressure requirement and the implement fluid pressure requirement to obtain a greatest system fluid pressure requirement.

9. The process of claim 6 further including obtaining fluid flow from said single hydraulic pump necessary to maintain said greatest system fluid pressure requirement.

10. The process of claim 9 including providing fluid flow to said implement at said implement fluid pressure requirement while maintaining said essential operation fluid pressure requirement.

11. A process for managing fluid flow requirements for an essential operation system and an implement system connected in parallel to a single pump hydraulic system, comprising:
obtaining an essential operation fluid pressure requirement from the essential operation system;
obtaining an implement fluid pressure requirement from the implement system;
determining a greatest system pressure requirement;
transmitting said greatest system pressure requirement signal the single pump hydraulic system;
obtaining fluid flow from said single pump hydraulic system to maintain said greatest system pressure requirement; and
maintaining an essential operation fluid flow to satisfy said essential operation fluid pressure requirement independent of said implement fluid pressure requirement.

12. The process of claim 11 including providing fluid flow to the implement system necessary to satisfy the implement fluid pressure requirement.

13. The process of claim 11 wherein the essential operation system is a tractor steering control system and the implement system is a pipelayer system.
